(19) United States
(12) Patent Application Publication
(10) Pub. No.: US 2026/0174611 A1
(43) Pub. Date: Jun. 25, 2026

(54) POSTURE ESTIMATION METHOD AND THERMAL MASSAGE MATTRESS USING THE SAME

(71) Applicant: CERAGEM Co., Ltd., Cheonan-si (KR)

(72) Inventors: Ki Won LEE, Hanam-si (KR); Mi Hyun LEE, Yongin-si (KR); Ji Hye KIM, Seoul (KR)

(73) Assignee: CERAGEM Co., Ltd., Cheonan-si (KR)

(21) Appl. No.: 18/988,969

(22) Filed: Dec. 20, 2024

(30) Foreign Application Priority Data
Oct. 25, 2023 (KR) 10-2023-0144197

(51) Int. Cl. A61G 7/057; A61H 15/00; A61H 15/02

(52) U.S. Cl. CPC A61G 7/057; A61H 15/02; A61H 2015/0021; A61H 2201/0146; A61H 2201/0207; A61H 2203/0456; A61H 2203/0468; A61H 2203/0475

(57) ABSTRACT

The present invention provides a thermal massage mattress that can estimate the lying position of a person lying on the mattress using a whole body pressure measurement sensor and perform various treatments based on the estimated position of the person. The estimation method includes: a measurement step of measuring pressure at each location through a plurality of pressure sensors arranged in a two-dimensional matrix; a body pressure characteristic extraction step of extracting a pressure value (force), a pressure action area (area), a peak pressure location (peak pressure), and an area average pressure (mean pressure) as ratio variables from the measured pressure information of the two-dimensional matrix; and a position estimation step of estimating a lying position from the extracted variables through a position estimation algorithm.

### TECHNICAL FIELD

The present invention relates to a position estimation method and a thermal massage mattress using the same.

Specifically, the present invention relates to a thermal massage mattress that can estimate the lying position of a person lying on the mattress using a whole body pressure measurement sensor and perform various treatments based on the estimated position of the person.

### BACKGROUND ART

A technology is being developed to identify the position of a person lying on a mattress and induce a stable position based on the identified position. As a method of identifying the position, a method of determining the position through the numerical value and distribution of body pressure measured by a person on a two-dimensional flat mattress, a method of photographing and analyzing the motion of a person, and a method of combining these methods have been developed.

However, the developed body pressure measurement method had a problem in that it could be applied only when the user lay down with his/her head and legs in a specific direction. In addition, the motion photographing method had problems in that the mattress installation location was limited for photographing and the user could not cover himself with a blanket.

### DISCLOSURE

### Technical Problem

The present invention has been devised to solve the above-described problems, and aims to provide a position estimation method that can estimate a user's lying position regardless of the installation location or direction of a mattress.

In addition, the present invention is to provide a position estimation method capable of accurately estimating a user's lying position even if the user lies down freely without recognizing the direction in which the user should lie down.

In addition, the present invention is to provide a position estimation method capable of accurately estimating a user's lying position.

In addition, the present invention is to provide a thermal massage mattress capable of providing a massage in response to a user's lying position.

In addition, the present invention is to provide a thermal massage mattress capable of identifying a user's sleeping pattern and creating the best sleeping environment in response to the user's lying position.

In addition, the present invention is to provide a thermal massage mattress capable of preventing bedsores by measuring a user's lying position.

The technical problems of the present invention are not limited to the above-mentioned objectives, and other objectives and advantages of the present invention that are not mentioned can be understood by the following description, and will be more clearly understood by the examples of the present invention. In addition, it will be easily understood that the objectives and advantages of the present invention can be realized by means indicated in the claims and combinations thereof.

### Technical Solution

A position estimation method according to the present invention for solving the above-described problems may be applied to a mattress on which a user can lie down and in which a plurality of pressure sensors arranged in a two-dimensional matrix are installed.

The position estimation method includes the steps of: measuring pressure at each location through a plurality of pressure sensors arranged in the form of a two-dimensional matrix, extracting body pressure characteristics from the measured pressure information of the two-dimensional matrix, and estimating a lying position from the extracted body pressure characteristics through a position estimation algorithm.

The step of extracting body pressure characteristics includes extracting a pressure location and a pressure intensity as variables from the measured pressure information.

The variables may include at least one of a pressure value (force), a pressure action area (area), a peak pressure location (peak pressure), and an area average pressure (mean pressure).

The variables may be extracted as a ratio.

When extracted as a ratio, body pressure analysis for people with different body types and weights can be performed without error.

In the position estimation step, a lying position is estimated from the extracted variables.

The lying position may be divided into a supine position, a prone position, and a lateral lying position.

The position estimation algorithm may divide the two-dimensional matrix into a plurality of sections along a length (height) direction of a person from the body pressure characteristics.

The plurality of sections may include: a first section corresponding to the head, a second section corresponding to the shoulder, chest, and back, a third section corresponding to the abdomen and lumbar spine, a fourth section corresponding to the hip and thigh, and a fifth section corresponding to the calf and foot.

The section including the shoulder may be the second section.

The section including the hip may be the fourth section.

The section including the calf may be the fifth section.

The division of the above sections may be made through a learned algorithm.

The division of the above sections may be made according to a specified predetermined body ratio.

The division of the above sections may be made through a learned algorithm, and when the division cannot be made by the learned algorithm, the division may be made according to a specified predetermined body ratio.

The position estimation algorithm may estimate the lying position by judging whether the body pressure characteristic in a predetermined section meets a predetermined judgment criterion.

In the position estimation algorithm, analysis may be sequentially performed for each section in a first scan direction from the head to the legs in the longitudinal direction, and auxiliary analysis may be performed in a second scan direction extending in the left-right direction. That is, the first scan direction may be a longitudinal direction, and the second scan direction may be a width direction.

The judgment criterion may include whether or not the pressure action area in a predetermined section is symmetrical left-right. Preferably, the criterion of the left-right symmetry may be a virtual axis extending in the longitudinal direction while passing through the head. The virtual axis may be parallel to the first scan direction.

The judgment criterion may include whether the peak pressure location exists in a predetermined section. This judgment criterion may be that the peak pressure location exists in the corresponding section, or that the peak pressure location does not exist in the corresponding section.

The judgment criterion may include whether the width of the pressure action area is greater than the length thereof in a predetermined section. This judgment criterion may be that the length of the pressure action area is greater than the width in the corresponding section, or that the width of the pressure action area is greater than the length in the section.

The judgment criterion may include whether or not the pressure value in a predetermined section is recognized as being equal to or greater than a reference value. This may include that the pressure value was not measured in the predetermined section, or that the pressure value was measured as being equal to or less than a reference value.

The judgment criterion may include at least one of the above-described judgment criteria.

The position estimation algorithm may judge whether the body pressure characteristic satisfies the estimation criterion in the estimation section, and if so, may additionally confirm whether the verification criterion is satisfied in the verification section to specify the lying position.

The estimation section may include at least one of a section including the shoulder, a section including the lumbar spine, and a section including the hips and thighs.

Preferably, the section including the shoulder may be an estimation section for estimating the lateral lying position.

Preferably, the section including the lumbar spine may be an estimation section for estimating the supine position.

Preferably, the section including the hips and thighs may be an estimation section for estimating the supine position and the prone position.

The verification section may include at least one of the section including the hips, the section including the hips and thighs, and the section including the calf.

Preferably, the section including the hips may be a verification section for verifying the lateral lying position, the supine position, and the prone position.

Preferably, the section including the hips and thighs may be a verification section for verifying the supine position.

Preferably, the section including the calf may be a verification section for verifying the supine position.

The position estimation algorithm may specify the user's position as a lateral lying position if the body pressure characteristic satisfies the estimation criteria of the lateral lying position in the section including the shoulder, and the verification criteria of the lateral lying position in the section including the hips.

Preferably, the estimation criterion may include that the pressure action area in the corresponding section is asymmetrical left-right.

Preferably, the verification criterion may include that the peak pressure location exists in the corresponding section.

The position estimation algorithm may specify the user's position as a supine position if the body pressure characteristic satisfies the estimation criteria of the supine position in the section including the lumbar spine, and the first verification criterion in the section including the calf.

Additionally, the position estimation algorithm may specify the user's position as a supine position if the body pressure characteristic satisfies the second verification criterion of the supine position in the section including the hips.

Preferably, the estimation criterion may include that in the corresponding section, the pressure value is recognized as being equal to or lower than a reference value or not recognized.

Preferably, the first verification criterion may include at least one of the following in the corresponding section: that the pressure action area is symmetrical left-right and that the length of the pressure action area is greater than the width.

Preferably, the second verification criterion may include that the peak pressure location exists in the corresponding section.

The position estimation algorithm may specify the user's position as a supine position if the body pressure characteristic satisfies the estimation criterion of the supine position in the section including the hips and thighs, and the verification criterion of the supine position in the section including the hips and thighs.

Preferably, the estimation criterion may include that, in the corresponding section, the pressure action area is symmetrical left-right and the width of the pressure action area is greater than the length.

Preferably, the verification criterion may include that the peak pressure location exists in the corresponding section.

The position estimation algorithm may specify the user's position as a prone position if the body pressure characteristic satisfies the estimation criteria of the prone position in the section including the hips and thighs, and the verification criteria of the prone position in the section including the hips.

Preferably, the estimation criterion may include that, in the corresponding section, the pressure action area is symmetrical left-right and the length of the pressure action area is greater than the width.

Preferably, the verification criterion may include that the peak pressure location does not exist in the corresponding section.

The present invention provides a massage mattress in which the position estimation method is performed.

The mattress comprises: a plurality of pressure sensors arranged in a two-dimensional matrix, and an operation control unit that extracts body pressure characteristics from pressure information measured by the pressure sensors and estimates a user's position.

The mattress may extract body information such as a user's body pressure distribution, height, and weight from information detected by the sensors, and may distinguish or specify the user thereby.

The mattress may further comprise a massage ceramic that can move in a direction parallel to the two-dimensional matrix and in a direction intersecting the two-dimensional matrix.

The massage ceramic may further include a thermal function.

The operation control unit may analyze a change in the user's sleep behavior from pressure information that changes over time.

The operation control unit may extract biosignals (heart rate, respiratory rate, etc.) through a change in pressure measured by the user's pressure sensors. In addition, through this, sleep patterns can be learned.

Through this, four stages of sleep state (wake-up during sleep, REM sleep, shallow sleep, and deep sleep) can be analyzed and provided as a report.

Through this, information on sleep disorders such as snoring or sleep apnea can also be provided as a report.

The operation control unit may perform temperature control for optimal sleep or prevention of low-temperature burns in response to the analyzed sleep behavior change.

The mattress may further comprise a temperature sensor that detects the user's body temperature.

The operation control unit may perform local temperature control for a predetermined location of the mattress through the thermal function of the ceramic. In addition, temperature control is also possible in a predetermined area or the entire area by moving the thermal ceramic.

The operation control unit may specify a user from pressure information measured by the pressure sensor.

The operation control unit may recommend a massage mode based on the specified user and the specified user's position, and automatically set the location of the massage ceramic.

As an example, the operation control unit may recommend or provide an optimal massage mode suitable for the distribution of the user's body pressure. For example, the body pressure distribution may be a body pressure distribution related to the spine, and the recommended massage mode may be a massage mode for the spine, wherein the massage mode may be determined by reflecting the body pressure distribution.

As another example, the operation control unit may learn a mode preferred by users having similar body pressure distributions using an artificial intelligence algorithm, and provide the learned massage mode. Preferably, this may be a mode of intensively massaging a specific region.

As another example, in response to a supine position, a prone position, or a lateral lying position, the operation control unit may set and provide a safety mode that is activated in the corresponding position.

For example, the operation control unit may set a massage start point of the ceramic from the extracted body pressure distribution of the user and set a movement trajectory of the ceramic.

When the operation control unit confirms, from pressure information that changes over time, that a portion where a pressure equal to or greater than a predetermined value acts continuously on a predetermined area occurs, it may move the massage ceramic to change the position to prevent bedsores.

The pressure sensor may function as an interface for receiving a user's input signal. Preferably, the input signal may be input in such a way that the pressure sensor detects a user's touch pressure. For example, when two consecutive touches are detected, the massage operation may be started or stopped. For example, when irregular consecutive touches are detected, it may be identified as an emergency situation, and the massage operation may be stopped immediately.

### Advantageous Effects

According to the position estimation method of the present invention, the user's lying position can be accurately estimated.

According to the position estimation method of the present invention, the user's lying position can be estimated regardless of the installation location or direction of the mattress.

According to the position estimation method of the present invention, the lying position can be accurately estimated even if the user lies down freely without recognizing the direction in which the user should lie down.

The thermal massage mattress of the present invention can provide a massage in response to the user's lying position.

The thermal massage mattress of the present invention can identify the user's sleep pattern and create the best sleeping environment.

The thermal massage mattress of the present invention can prevent bedsores by measuring and continuously monitoring the user's lying position and changing the user's position using a ceramic.

In addition to the above-described effects, the specific effects of the present invention will be described together with the specific matters for implementing the invention below.

### DESCRIPTION OF DRAWINGS

FIG. 1 is a view showing a state in which a user is lying on a mattress according to the present invention.

FIG. 2 is a graph showing body pressure distribution measured by a pressure sensor arranged in the form of a two-dimensional matrix in the lying state of the user in FIG. 1.

FIG. 3 is a graph showing a state in which body pressure distribution is divided into a plurality of sections based on the body pressure distribution measured by the pressure sensor.

FIG. 4 is a graph showing a state of being divided into a plurality of sections in response to the body pressure distribution of a user lying in various positions, respectively, wherein (a) shows a lateral lying position, (b) shows a supine position, and (c) shows a prone position.

FIG. 5 is a flowchart of a position estimation method of an embodiment.

FIG. 6 is a perspective view showing an embodiment of a thermal ceramic applied to a mattress of the present invention and a guide rail guiding the same.

FIG. 7 is a plan view of the thermal ceramic of FIG. 6.

FIG. 8 is a plan view showing a state in which the thermal ceramic of FIG. 7 is aligned to correspond to the lying position of the user by an operation control unit.

FIG. 9 is a side view of the thermal ceramic of FIG. 8.

FIG. 10 is an enlarged perspective view of the thermal ceramic in FIG. 6 with the guide rail omitted.

FIG. 11 is a side view of FIG. 10.

FIG. 12 is a side view showing a state in which the lifting body in FIG. 11 is raised.

### MODES OF THE INVENTION

Hereinafter, preferred embodiments of the present invention will be described in detail with reference to the attached drawings.

The present invention is not limited to the embodiments disclosed below, but may be variously modified and implemented in various different forms. These embodiments are provided only to ensure that the disclosure of the present invention is complete and to fully inform those skilled in the art of the scope of the invention. Therefore, the present invention is not limited to the embodiments disclosed below, but should be understood to include not only substituting the configuration of one embodiment with the configuration of another embodiment or adding the configuration of one embodiment to the configuration of another embodiment, but also all changes, equivalents, or substitutes included in the technical idea and scope of the present invention.

The accompanying drawings are only for easy understanding of the embodiments disclosed in the present specification, and the technical idea disclosed in the present specification is not limited by the accompanying drawings, and should be understood to include all changes, equivalents, and substitutes included in the spirit and scope of the present invention. In the drawings, components may be expressed exaggeratedly large or small in size or thickness for convenience of understanding, but this should not be construed as limiting the protection scope of the present invention.

The terms used in this specification are only used to describe specific implementations or embodiments, and are not intended to limit the present invention. In addition, singular expressions include plural expressions unless the context clearly implies otherwise. In the specification, terms such as “include” and “comprise” are intended to specify the presence of features, numbers, steps, operations, components, parts, or combinations thereof described in the specification. That is, in the specification, terms such as “include” and “comprise” should be understood as not excluding in advance the possibility of the presence or addition of one or more other features, numbers, steps, operations, components, parts, or combinations thereof.

Terms including an ordinal number, such as first, second, etc., may be used to describe various components, but the components are not limited by the terms. The terms are used only for the purpose of distinguishing one component from another. Therefore, it goes without saying that a first component may also be a second component, unless otherwise stated.

When a component is referred to as being “connected” or “contacted” with another component, it should be understood that although they may be directly connected or contacted with each other, other components may exist therebetween. On the other hand, when a component is referred to as “directly connected” or “directly contacted” with another component, it should be understood that no other component exists therebetween.

When a component is referred to as being “above” or “below” another component, it should be understood that they are not only positioned directly above or below each other, but that other components may also be present therebetween.

Unless otherwise defined, all terms used herein, including technical or scientific terms, have the same meaning as commonly understood by one of ordinary skill in the art to which the present invention belongs. Terms such as those defined in commonly used dictionaries should be interpreted as having a meaning consistent with their meaning in the context of the relevant art, and will not be interpreted in an idealized or overly formal sense unless expressly defined in this application.

Throughout the specification, the expression “A and/or B” refers to A, B, or A and B, unless otherwise specifically stated, and the expression “C to D” means C or more and D or less, unless otherwise specifically stated.

### [Posture Estimation Method]

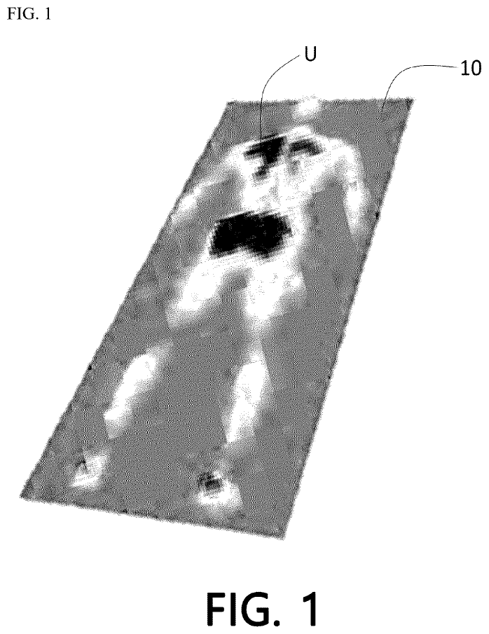

Hereinafter, with reference to FIGS. 1 to 5, a method for estimating a user's lying position according to an embodiment of the present invention will be described.

The method for estimating a position according to an embodiment may be applied to a thermal massage mattress 10. The mattress 10 provides a rectangular flat floor on which a user (U) can lie down. The mattress 10 may have various forms, such as a fixed type, a folding/unfolding type, a roll/unroll type, and the present invention does not limit the deployment type of the mattress 10.

A plurality of pressure sensors 11 may be embedded in the mattress 10 in the form of a two-dimensional matrix grid. Accordingly, when the user is lying on the mattress 10, each pressure sensor 11 measures the body pressure acting on the corresponding portion and provides the measured pressure to an operation control unit 60 as an electrical signal.

The pressure sensor 11 may be a pressure sensor that is so flexible that the locations of the pressure sensors cannot be identified even when the user (U) lies down.

The operation control unit 60 may analyze the body pressure distribution measured by the pressure sensor 11 to determine the user's longitudinal direction (length direction, height direction, first direction) and width direction (left-right direction, second direction). For example, the longitudinal direction may correspond to a direction in which the user's head and spine extend.

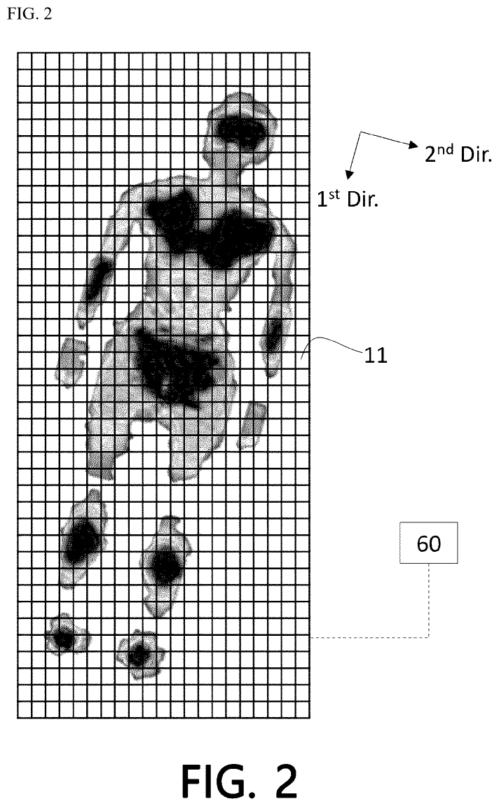

Referring to FIG. 2, even when the user lies down somewhat obliquely, the operation control unit 60 can accurately determine the longitudinal direction and width direction by analyzing the user's body pressure distribution. It is obvious that the above analysis and determination may occur even when the user lies down with the head and legs upside down.

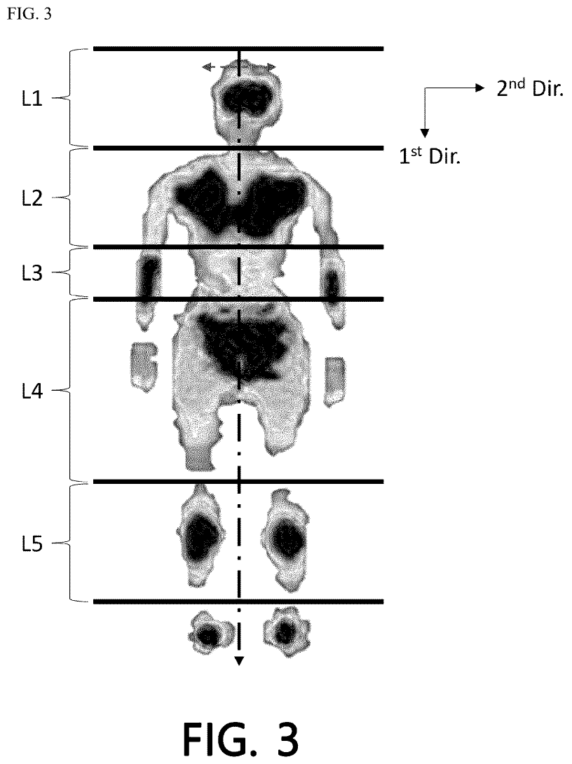

Referring to FIG. 3, the operation control unit 60 may analyze the body pressure distribution measured by the pressure sensor 11 and divide it into a plurality of sections connected in series along the first direction.

In the embodiment, it is illustrated that the above section is divided into five sections. The five sections may be a first section (L1) including the head, a second section (L2) including the shoulders, chest, and back, a third section (L3) including the abdomen, waist, and lumbar spine, a fourth section (L4) including the buttocks and thighs, and a fifth section (L5) including the calf.

However, the division locations of each section are not limited to the above. For example, the fourth section may be a section including only the buttocks, and the fifth section may be a section including not only the calf but also the feet.

The division of the above sections may be made through a learned algorithm. However, when the division cannot be made by the learned algorithm, it may be made according to a specified predetermined body ratio.

For example, the specification of the body ratio may be made based on the ‘Korean Human Body Standard Information’ database conducted by the Korean Agency for Technology and Standards of the Ministry of Trade, Industry and Energy. Specifically, referring to the database according to the ‘8th Human Dimension Survey Project’, based on a man in his 30s, based on the top and bottom points in the direction of height after recognizing the user's height, from the top to the bottom, that is, from the head to the feet, the first section may be 15%, the second section 16%, the third section 12.7%, the fourth section 28.8%, and the fifth section 27.5%.

The first section may be from the top of the body recognized to the back of the neck, the second section may be from the back of the neck to the bottom of the breasts, the third section may be from the bottom of the breasts to the waist, the fourth section may be from the waist to the middle of the kneecap, and the fifth section may be from the middle of the kneecap to the bottom of the body recognized.

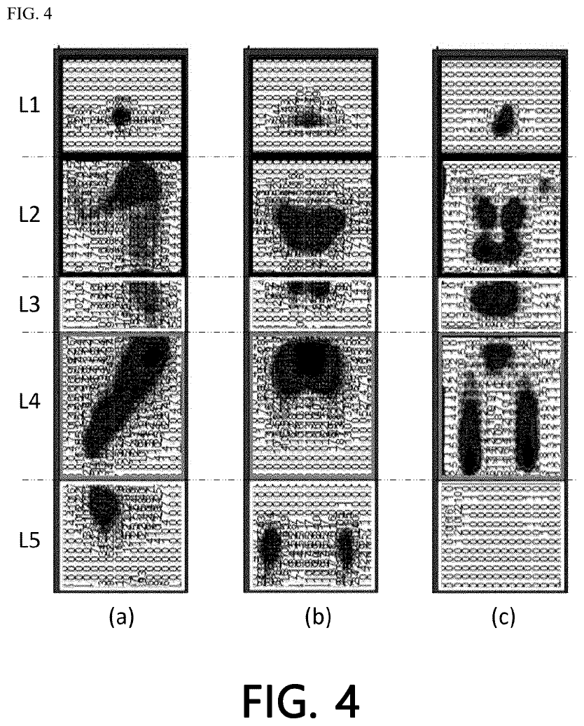

Referring to FIG. 4, the characteristics of the body pressure distribution of respective sections may be clearly distinguished depending on the user's lying position. For reference, (a) represents a lateral lying position, (b) represents a supine position, and (c) represents a prone position.

In the first section (L1), it can be confirmed that there is one pressure action area in the center of the width direction in any case. The operation control unit 60 may quickly identify the location of the head by identifying the characteristics of this pressure action area, and use it as a reference.

In the second section (L2), the difference between the lateral lying position (a) and other positions (b, c) is clearly distinguished. That is, in the lateral lying position (a), unlike other positions, the pressure action area corresponding to the shoulder is asymmetrical left-right, and the pressure value is also clearly asymmetrical left-right.

In the third section (L3), the difference between the supine position (b) and other positions (a, c) is clearly distinguished. That is, in the supine position (b), unlike other positions, the pressure value corresponding to the lumbar spine is small, and the pressure action area is also very small.

Looking at the fourth section (L4), the side-lying position (a) and the supine position (b) have the peak pressure location in the buttocks, while the prone position (c) does not.

Looking at the fourth section (L4) again, the pressure action area and pressure value in the supine position (b) and the prone position (c) are symmetrical left-right, while the side-lying position (a) does not.

Looking at the fourth section (L4) again, in the supine position (b), the pressure action area has a left-right width longer than a longitudinal length, whereas in the prone position (c), the pressure action area has a longitudinal length longer than a left-right width.

Looking at the fifth section (L5), in the supine position (b), the pressure value and the pressure action area are symmetrical left-right, and the pressure action area has a longitudinal length longer than a left-right width, whereas the other positions (a, c) do not have these features at all.

In order to increase the reliability of the position estimation result by clearly extracting features that distinguish a specific position from other positions, the position estimation method of the embodiment causes the operation control unit 60 to extract a pressure value (force), a pressure action area (area), a peak pressure location (peak pressure), and an area average pressure (mean pressure) as ratio variables from the measured pressure information of the two-dimensional matrix.

Then, based on the features of the extracted variables in each section, it is possible to accurately determine the user's lying position.

Extracting as a ratio can be understood to mean applying a relative value of a numerical value, not an absolute value of a numerical value. For example, the pressure value of each point in the two-dimensional matrix pressure information measured from a person weighing 50 kg may be generally lower than the pressure value of each point in the two-dimensional matrix pressure information measured from a person weighing 80 kg. When the position is estimated based on the absolute numerical values that are different for each person as mentioned above, there is a possibility of error in the estimation process.

On the other hand, when variables are extracted as ratios, standardized variables can be derived regardless of the differences in weight or body shape of these people. For example, the value obtained by dividing the two-dimensional matrix pressure information measured from a person weighing 50 kg by 50 means a predetermined ratio, and the value obtained by dividing the two-dimensional matrix pressure information measured from a person weighing 80 kg by 80 also means a predetermined ratio. When the variables of two people are extracted as ratios in this way, the position can be estimated from the standardized variables regardless of the user's body shape or weight, thereby increasing the reliability of the position estimation results.

As shown in FIG. 3, the algorithm for estimating position from these extracted variables may sequentially perform analysis for each section in the first direction from the head to the legs (first scan direction), and may supplementally perform analysis in the second direction corresponding to the width direction (second scan direction).

As will be described later, these scan directions are directions for implementing the position estimation algorithm most quickly and accurately. Accordingly, the lateral lying position can be determined most quickly, and further, the supine position and the prone position can sequentially be determined quickly.

This is because the estimation section of each position is arranged close to the head, and if the estimation criteria are met in the estimation section of each position, other analyses can be skipped and it can be immediately confirmed whether the verification criteria are met in the verification section.

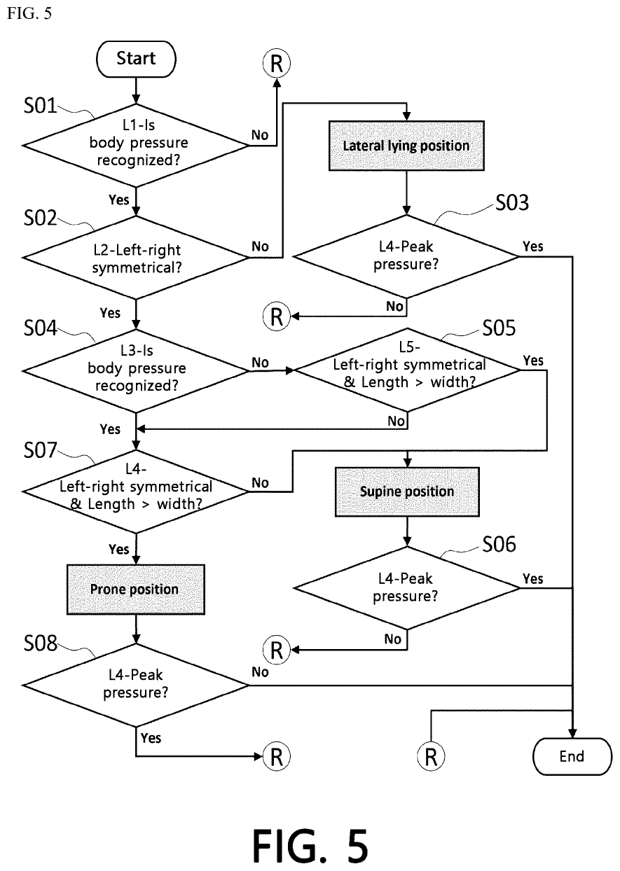

The operation control unit 60 extracts the body pressure distribution data measured by the pressure sensor 11 as the variable described above, and estimates the position according to the algorithm shown in FIG. 5.

First, it is determined whether body pressure is recognized in the first section (L1) (S01). If the body pressure of the head is recognized, it can be said that there is no problem with the extracted variable, so it proceeds to the next step (S02). On the other hand, if the body pressure is not recognized, it cannot be ruled out that there may be an error in the extracted variable, so a reset is performed and the algorithm is terminated.

Next, it is determined whether the pressure value and the pressure action area in the second section (L2) are symmetrical left-right (S02). The second section (L2) is a section that includes the shoulder and may be an estimation section of the lateral lying position.

When the variable extracted in the second section (L2) is asymmetrical left-right, this can be a basis for estimating that it is a lateral lying position. That is, the estimation criterion of the lateral lying position is that the body pressure characteristic in the second section (L2) is asymmetrical left-right.

When the body pressure characteristic in the estimation section of the lateral lying position meets the estimation criterion as described above, verification is performed (S03). The verification is performed by determining whether the peak pressure location exists in the section corresponding to the buttocks in the fourth section (L4) including the buttocks. That is, the verification section of the lateral lying position is the fourth section (L4), and the verification criterion of the lateral lying position is that the peak pressure location exists in the section corresponding to the buttocks.

When the verification criterion is met, the algorithm determines that the lying position of the user (U) is a lateral lying position, and the algorithm is terminated.

On the other hand, when the verification criterion is not met, data errors cannot be ruled out, so a reset is performed and the algorithm is terminated.

Meanwhile, when the variables extracted from the second section (L2) are symmetrical left-right, it can be determined that it is not a lateral lying position, and the next step (S04) is performed.

In the step (S04), it is determined whether body pressure is recognized in the third section (L3) or whether the body pressure is less than or equal to a predetermined value. If the body pressure of the lumbar spine is not recognized or is minimally recognized, this can be a basis for estimating that it is a supine position. That is, the third section (L3) can be an estimation section of the supine position, and the fact that the body pressure is minimal or not recognized can be an estimation criterion of the supine position.

When the body pressure characteristic in the estimation section of the supine position meets the estimation criterion as described above, verification is performed (S05). The verification step includes a procedure of confirming whether the body pressure distribution of the fifth section (L5) is symmetrical left-right and whether the length of the pressure action area is longer than the width.

That is, the fifth section (L5) may be a verification section of the supine position, and the left-right symmetry of the body pressure distribution and the longer pressure action area in the longitudinal direction may be a verification criterion.

When the body pressure distribution meets the verification criterion, additional verification is performed (S06). The additional verification is performed by determining whether the peak pressure location exists in the section corresponding to the buttocks in the fourth section (L4) including the buttocks. That is, the additional verification section of the supine position is the fourth section (L4), and the additional verification criterion of the supine position is that the peak pressure location exists in the section corresponding to the buttocks.

When the additional verification criterion is met, the algorithm determines that the lying position of the user (U) is a supine position, and the algorithm is terminated.

On the other hand, when the verification criteria are not met (S05), the next step (S07) of examining the body pressure distribution characteristics of the fourth section (LA) is performed, and when the additional verification criteria are not met (S06), a data error cannot be ruled out, so a reset is performed and the algorithm is terminated.

If the body pressure distribution of the fourth section (L4) is symmetrical left-right and the length of the pressure action area is greater than the width, it is estimated to be a prone position (S07). That is, the fourth section (L4) becomes the estimation section of the prone position, and the fact that it is symmetrical left-right and the length of the pressure action area is greater than the width becomes the estimation criterion of the prone position.

When it is estimated to be a prone position in the step (S07), the verification step (S08) is performed. This is to confirm whether the peak pressure location does not exist in the section including the buttocks in the fourth section (L4). That is, the fourth section (L4) becomes the verification section of the prone position, and the absence of the peak pressure location becomes the verification criterion.

When the peak pressure location does not exist in the section including the buttocks in the step (S08), the algorithm determines that the lying position of the user (U) is the prone position, and the algorithm is terminated.

On the other hand, when the verification criterion is not met in the step (S08), a data error cannot be ruled out, so a reset is performed and the algorithm is terminated.

Meanwhile, when it is not estimated to be a prone position in the step (S07), that is, when the body pressure distribution is symmetrical left-right and the width of the pressure action area is greater than the length, it is estimated to be a supine position. That is, the fourth section (L4) becomes the estimation section of the supine position, and the fact that it is symmetrical left-right and the width of the pressure action area is greater than the length becomes the estimation criterion of the supine position.

When it is estimated to be a supine position in the step (S07), the verification step (S06) is performed. This is performed by determining whether the peak pressure location exists in the section corresponding to the buttocks in the fourth section (L4) including the buttocks. When the peak pressure location exists in the section corresponding to the buttocks in the fourth section (L4), the algorithm determines that the lying position of the user (U) is a supine position, and the algorithm is terminated.

On the other hand, if not, data errors cannot be ruled out, so a reset is performed and the algorithm is terminated.

According to the position estimation algorithm discussed above, the estimation basis in each step is very clear and reliable. In addition, it can be said that each step is performed in an order in which the lying position can be quickly and accurately determined.

### [Thermal Massage Mattress]

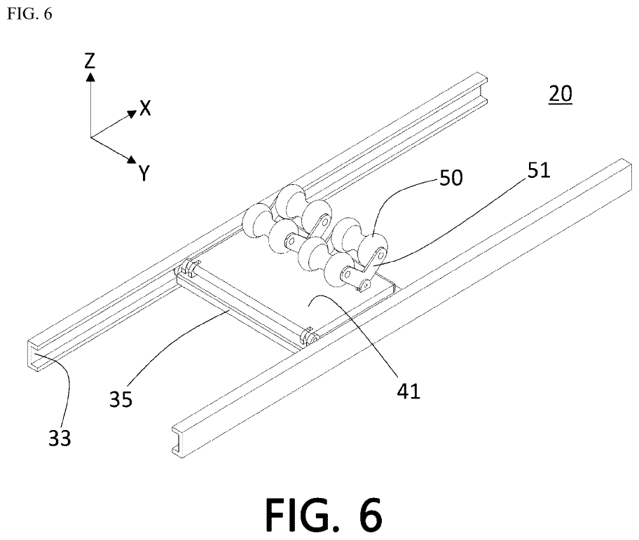

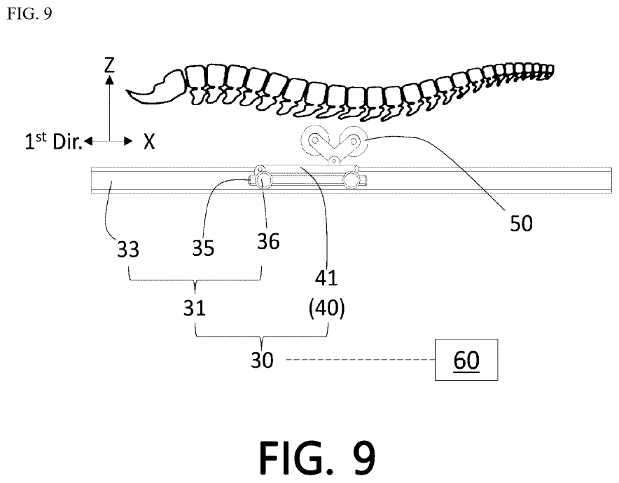

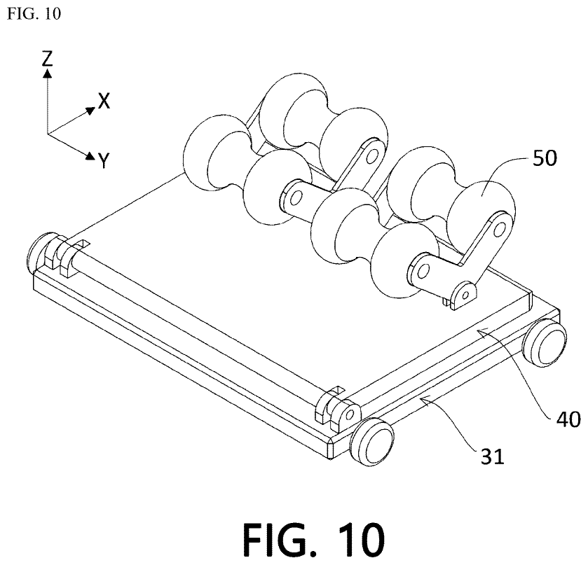

Hereinafter, with reference to FIGS. 6 to 12, a thermal massage mattress to which the above-described position estimation method is applied will be described in detail.

A predetermined installation space in which a massage device 20 shown in FIG. 6 is installed is provided under the surface of the mattress 10 shown in FIG. 1.

The massage device 20 comprises: a thermal massage ceramic 50 that heats and presses a user (U) while contacting a body region of the user (U) that is in contact with the mattress 10 on which the user (U) is lying, a driving unit 30 that moves the thermal massage ceramic 50, and an operation control unit 60 that controls the driving unit 30.

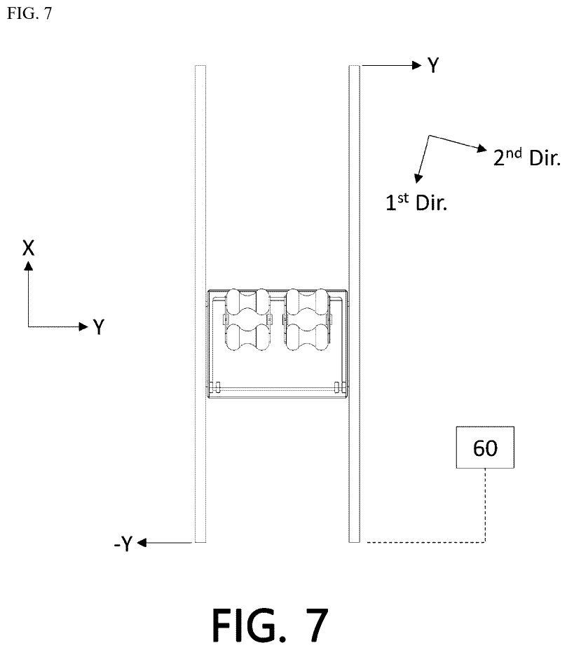

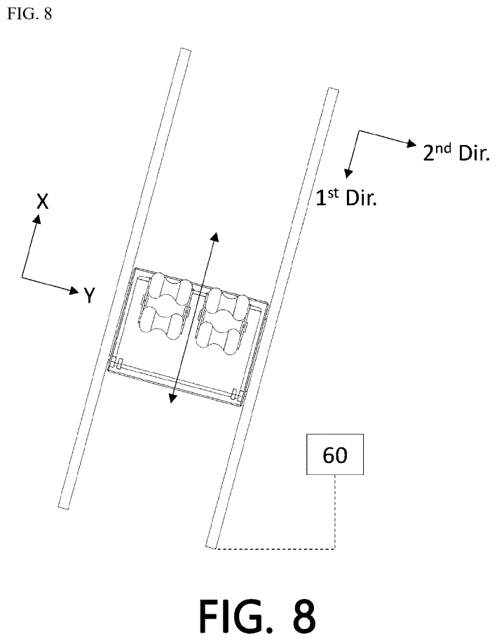

Referring to FIGS. 7 and 8, the operation control unit 60 may align the X-axis direction of the massage device 20 to correspond to the first direction of the body pressure distribution measured and analyzed from the pressure sensor 11. The embodiment exemplifies a method of aligning the X-axis direction with the first direction by moving at least one of one end and the other end of the massage device 20 in the X-axis direction in the Y-axis direction intersecting the X-axis direction.

The thermal massage ceramic 50 can reciprocate in the X-axis direction. The X-axis may extend parallel to the mattress 10. The thermal massage ceramic 50 may ascend and descend in the Z-axis direction intersecting the mattress 10. The Z-axis may be orthogonal to a plane including the mattress 10.

The driving unit 30 includes: a lifting part 40 that moves the thermal massage ceramic 50 in the Z-axis direction and the opposite direction, and a traveling part 31 that moves the thermal massage ceramic 50 in the X-axis direction and the opposite direction.

The traveling part 31 includes a pair of guide rails 33 that extend in the X-axis direction and are spaced apart in the Y-axis direction that is orthogonal to both the Z-axis direction and the X-axis direction, and a traveling body 35 that travels along the guide rails 33 in the X-axis direction and the opposite direction.

The guide rails 33 may be spaced apart from each other in the Y-axis direction with, for example, a human spine interposed therebetween. The Y-axis direction may be a left-right direction. The guide rails 33 do not have to extend straight in the X-axis direction. For example, the guide rails 33 may have a bend in a range that substantially corresponds to the extension direction of the human spine.

The traveling body 35 may include wheels 36 spaced apart in the X-axis direction and guided in movement by the guide rail 33. That is, four wheels 36 may be provided, and may be provided in a form spaced apart in the X-axis direction at both ends of the traveling body 35 in the Y-axis direction.

The thermal massage ceramic 50 is installed on the lifting part 40. The lifting part 40 is installed on the traveling body 35 so that the thermal massage ceramic 50 can move relatively in the Z-axis direction and the opposite direction with respect to the traveling body 35.

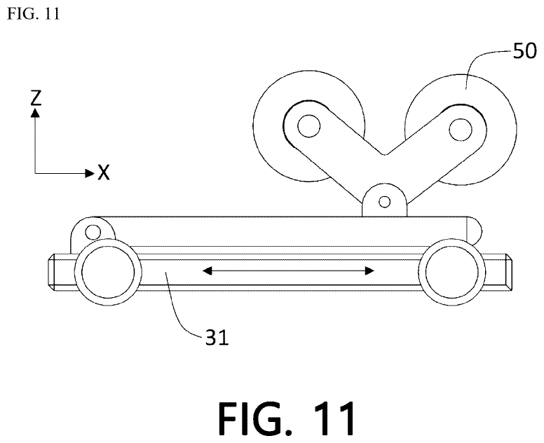

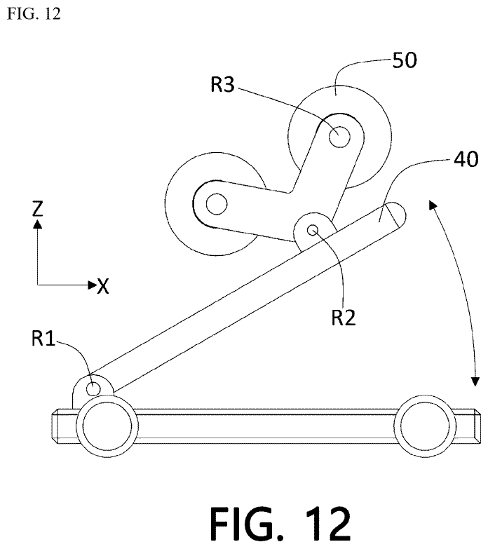

The lifting part 40 includes an lifting body 41 that rotates about an lifting center (R1) that extends in the Y-axis direction at the caudal end of the traveling body 35 in the X-axis direction. When the lifting body 41 rotates about the lifting center (R1), the other end of the lifting body 41 in the X-axis direction ascends substantially in the Z-axis direction as shown in FIG. 12 or descends in the opposite direction as shown in FIG. 11.

A pivot arm 51 that pivots about a pivot center (R2) that extends in the Y-axis direction is provided at the cranial end of the lifting body 41 in the X-axis direction. The pivot arm 51 extends from the pivot center (R2) in the X-axis direction and also in the opposite direction. The pivot arm 51 may extend in a “V” shape from the pivot center (R2).

Both ends of the pivot arm 51 in the X-axis direction are provided with a pair of ceramics 50 that are installed to be rotatable about rotation centers (R3) extending in the Y-axis direction, respectively. The virtual axes of the rotation centers (R3) may pass through the ceramics 50, respectively.

The rotation center (R3) of the first ceramic installed at the caudal front end of the pivot arm 51 in the X-axis direction is disposed between the pivot center (R2) and the lifting center (R1) in the X-axis direction. The pivot center (R2) is disposed between the lifting center (R1) and the rotation center (R3) of the second ceramic installed at the cranial front end of the pivot arm 51 in the X-axis direction.

The ceramic may be a heater having a built-in heating element.

The traveling motion of the traveling body 35 and the lifting motion of the lifting part 40 may be controlled by the operation control unit 60. That is, the operation control unit 60 may control the driving unit 30 to move the thermal massage ceramic 50 in the Z-axis direction and the opposite direction, and also in the X-axis direction and the opposite direction.

The embodiment exemplifies a structure in which the lifting body 41 is rotated about the lifting center (R1) of the other end in the X-axis direction to lift one end of the lifting body 41 in the X-axis direction in order to move the thermal massage ceramic 50 in the Z-axis direction and the opposite direction. However, the lifting body 41 may also be rotated about the lifting center (R1) of one end in the X-axis direction to lift the other end of the lifting body 41 in the X-axis direction in order to move the thermal massage ceramic 50 in the Z-axis direction and the opposite direction. In addition, of course, the lifting body 41 may also be slid and moved in the Z-axis direction and the opposite direction relative to the traveling body 35 to move the thermal massage ceramic 50 in the Z-axis direction and the opposite direction.

The operation control unit 60 may extract not only the extracted variables described above, but also body information such as the user's body pressure distribution, height, and weight, from the pressure information detected through the pressure sensor 11. Thereby, the operation control unit 60 may also distinguish or specify the user.

The operation control unit 60 may analyze a change in the user's sleep behavior through a trend in which the pressure information measured from the pressure sensor 11 changes over time. The change in the sleep behavior may include the user's tossing and turning or a change in the lying position.

The operation control unit 60 may also extract biosignals (heart rate, respiratory rate, etc.) through a change in pressure measured by the user's pressure sensors.

The operation control unit 60 may learn the sleep pattern of the user (U) through the above-mentioned data analysis.

The operation control unit 60 may analyze four-stage sleep state of the user (U) through the data analysis and sleep pattern learning as described above.

Sleep is divided into several stages, and is largely divided into REM (rapid eye movement) sleep, in which the eyeball moves rapidly and wildly, and NREM (non-rapid eye movement) sleep, in which the eyeball does not so.

The REM sleep, in which rapid eyeball movement occurs, is a sleep in which you sleep while dreaming, and has the characteristic of irregular heartbeat and breathing. Neuroscientists argue that memories are stored during this REM sleep period.

The NREM sleep is again classified into four stages: shallow sleep (stage 1) to deep sleep (stage 4), depending on the depth of sleep. Sleep changes from stages 1 and 2 to stages 3 and 4 and then to REM sleep. This process is repeated 3 to 5 times overnight.

There is still a lot of controversy over which of REM or NREM is deeper, but all sleep in the fetus is REM. In general, in the case of adult sleep, shallow sleep of NREM sleep is half or more, deep sleep is 15% or less, and REM sleep is about 25%.

The sleep state analyzed in this way may be provided to the user in the form of a report.

In addition, information on sleep disorders such as snoring or sleep apnea can be analyzed through the change in body pressure as described above, and this may also be provided as a report.

The operation control unit 60 may perform temperature control for optimal sleep or prevention of low-temperature burns in response to the analyzed sleep behavior change.

The mattress 10 further comprises a temperature sensor that detects the user's body temperature. The temperature sensor may be provided in a form integrated with the flexible pressure sensor 11 described above, or in the form of a separate layer stacked to the flexible pressure sensor 11.

The operation control unit 60 may perform local temperature control for a predetermined location of the mattress 10 through the thermal function of the ceramic 50.

In addition, the operation control unit 60 can control the temperature for a predetermined area of the mattress 10 through the operation of periodically moving the thermal ceramic. According to this principle, it is obvious that temperature control for the entire area of the mattress 10 is also possible.

The operation control unit 60 may recommend a massage mode based on a user and the position of the user specified through body pressure distribution analysis or body information such as weight and height.

The operation control unit 60 may recommend or provide an optimal massage mode suitable for the distribution of the user's body pressure.

Here, the body pressure distribution may be a body pressure distribution related to the spine.

Here, the recommended massage mode may be a massage mode for the spine.

Here, the massage mode may be determined by reflecting the body pressure distribution.

The operation control unit 60 may learn a mode preferred by users having similar body pressure distributions using an artificial intelligence algorithm.

The operation control unit 60 may provide the massage mode learned in this way.

The operation control unit 60 may provide a mode that intensively massages an optimal specific region in response to the specific user and the body pressure distribution according to his/her sleeping position.

In response to a supine position, a prone position, or a lateral lying position, the operation control unit 60 may set and provide a safety mode that is activated in the corresponding position.

The operation control unit 60 may automatically set the location of the massage ceramic 50 based on a user (U) and the position of the user specified through body pressure distribution analysis or body information such as weight and height.

The operation control unit 60 may set a massage start point of the ceramic 50 based on the extracted body pressure distribution of the user and move the ceramic 50 to the corresponding location.

The operation control unit 60 may set the movement trajectory of the ceramic based on the extracted body pressure distribution of the user.

The flexible pressure sensor 11 of the mattress 10 may function as an interface for receiving a user's input signal. The input signal may be input through the pressure sensor in such a way that the pressure sensor detects the user's touch pressure. For example, when the pressure sensor 11 detects two consecutive touches of the user (U), the operation control unit 60 may start or stop the massage operation of the ceramic 50. For example, when the pressure sensor 11 detects irregular continuous touches of the user (U), the operation control unit 60 may recognize this as an emergency situation and immediately stop the massage operation of the ceramic 50.

In addition, the operation control unit 60 continuously monitors pressure information that changes over time. When the operation control unit 60 confirms that a pressure greater than or equal to a predetermined value is continuously applied to a predetermined area during the monitoring, it may change the position of the user (U) using the massage ceramic 50. This can prevent bedsores.

It should be understood that the above-described embodiments are illustrative and not restrictive in all respects, and the scope of the present invention will be indicated by the claims to be described later rather than the detailed description made above. In addition, the meaning and scope of the claims to be described later, as well as all changes and modifications derived from the equivalent concepts thereof, should be interpreted as being included in the scope of the present invention.

Although the present invention has been described with reference to the exemplified drawings above, the present invention is not limited to the embodiments and drawings disclosed in this specification, and it is obvious that various modifications can be made by those skilled in the art within the scope of the technical idea of the present invention. In addition, even if the operations and effects according to the configuration of the present invention were not explicitly described while describing the embodiments of the present invention, it is natural that the effects predictable by the corresponding configuration should also be acknowledged.

### DESCRIPTION OF REFERENCE NUMERALS AND SYMBOLS

10: Massage mattress
11: Pressure sensor
20: Massage device
30: Driving unit
31: Traveling part
33: Guide rail
35: Traveling body
36: Wheel
40: Lifting part
41 Lifting body
R1: Lifting center
50: Thermal massage ceramic
51: Pivot arm
R2: Pivot center
R3: Rotation center
60: Operation control unit
U: User
L1: First section (Head section)
L2: Second section (Shoulder-chest section)
L3: Third section (Abdomen-waist section)
L4: Fourth section (Hip-thigh section)
L5: Fifth section (Calf-foot section)

1. A position estimation method including:
a measurement step of measuring pressure at each location through a plurality of pressure sensors arranged in a two-dimensional matrix;
a body pressure characteristic extraction step of extracting pressure location and pressure intensity as variables from the measured pressure information of the two-dimensional matrix; and
a position estimation step of estimating a lying position from the extracted variables through a position estimation algorithm.

2. The position estimation method according to claim 1, wherein the variables include at least one of a pressure value (force), a pressure action area (area), a peak pressure location (peak pressure), and an area average pressure (mean pressure).

3. The position estimation method according to claim 1, wherein the variables are extracted as ratios.

4. The position estimation method according to claim 1, wherein the position estimation algorithm divides the two-dimensional matrix into a plurality of sections along a length (height) direction of a person from the body pressure characteristics.

5. The position estimation method according to claim 4, wherein the plurality of sections include: a first section corresponding to the head, a second section corresponding to the shoulder, chest, and back, a third section corresponding to the abdomen and lumbar spine, a fourth section corresponding to the hip and thigh, and a fifth section corresponding to the calf and foot.

6. The position estimation method according to claim 4, wherein the position estimation algorithm estimates the lying position by judging whether the body pressure characteristic in a predetermined section meets a predetermined judgment criterion.

7. The position estimation method according to claim 6, wherein in the position estimation algorithm, analysis is sequentially performed for each section in the direction from the head to the legs, and auxiliary analysis is performed in the width direction.

8. The position estimation method according to claim 6, wherein the judgment criterion include at least one of:
whether the pressure action area in a predetermined section is symmetrical left-right,
whether the peak pressure location exists in a predetermined section,
whether the width of the pressure action area is greater than the length thereof in a predetermined section, and
whether the pressure value in a predetermined section is recognized as being equal to or greater than a reference value.

9. The position estimation method according to claim 6, wherein the lying position is divided into a supine position, a prone position, and a lateral lying position.

10. The position estimation method according to claim 4, wherein the position estimation algorithm specifies the lying position by confirming whether the body pressure characteristic satisfies the estimation criterion in the estimation section and the verification criterion in the verification section.

11. The position estimation method according to claim 10, wherein the estimation section includes at least one of a section including the shoulder, a section including the lumbar spine, and a section including the hips and thighs, and
the verification section includes at least one of a section including the hips, a section including the hips and thighs, and a section including the calf.

12. The position estimation method according to claim 4, wherein the position estimation algorithm specifies the user's position as a lateral lying position if the body pressure characteristic satisfies the estimation criteria of the lateral lying position in the section including the shoulder, and the verification criteria of the lateral lying position in the section including the hips.

13. The position estimation method according to claim 11, wherein the estimation criterion includes that the pressure action area in the corresponding section is asymmetrical left-right, and
the verification criterion includes that the peak pressure location exists in the corresponding section.

14. The position estimation method according to claim 4, wherein the position estimation algorithm specifies the user's position as a supine position if the body pressure characteristic satisfies the estimation criteria of the supine position in the section including the lumbar spine, and the first verification criterion in the section including the calf.

15. The position estimation method according to claim 14, wherein the estimation criterion includes that in the corresponding section, the pressure value is recognized as being equal to or lower than a reference value or not recognized.
the first verification criterion include at least one of the following in the corresponding section: that the pressure action area is symmetrical left-right and that the length of the pressure action area is greater than the width.

16. The position estimation method according to claim 15, wherein the position estimation algorithm additionally specify the user's position as a supine position if the body pressure characteristic satisfies the second verification criterion of the supine position in the section including the hips, and
the second verification criterion includes that the peak pressure location exists in the corresponding section.

17. The position estimation method according to claim 4, wherein the position estimation algorithm specifies the user's position as a supine position if the body pressure characteristic satisfies the estimation criterion of the supine position in the section including the hips and thighs, and the verification criterion of the supine position in the section including the hips and thighs.

18. The position estimation method according to claim 17, wherein the estimation criterion includes that in the corresponding section, the pressure action area is symmetrical left-right and the width of the pressure action area is greater than the length, and
the verification criterion includes that the peak pressure location exists in the corresponding section.

19. The position estimation method according to claim 4, wherein the position estimation algorithm specifies the user's position as a prone position if the body pressure characteristic satisfies the estimation criteria of the prone position in the section including the hips and thighs, and the verification criteria of the prone position in the section including the hips.

20. The position estimation method according to claim 19, wherein the estimation criterion includes that in the corresponding section, the pressure action area is symmetrical left-right and the length of the pressure action area is greater than the width, and
the verification criterion includes that the peak pressure location does not exist in the corresponding section.

21. A massage mattress in which the position estimation method of the claim 1 is performed,
wherein the mattress comprises:
a plurality of pressure sensors arranged in a two-dimensional matrix;
an operation control unit that extracts body pressure characteristics from pressure information measured by the pressure sensors and estimates a user's position; and
a massage ceramic that can move in a direction parallel to the two-dimensional matrix and in a direction intersecting the two-dimensional matrix.

22. The massage mattress according to claim 21, wherein the massage ceramic further includes a thermal function.

23. The massage mattress according to claim 22, wherein the operation control unit analyzes a change in the user's sleep behavior from pressure information that changes over time.

24. The massage mattress according to claim 23, wherein the operation control unit performs temperature control for optimal sleep or prevention of low-temperature burns in response to the analyzed sleep behavior change.

25. The massage mattress according to claim 22, wherein the operation control unit specifies a user from pressure information measured by the pressure sensor.

26. The massage mattress according to claim 25, wherein the operation control unit recommends a massage mode based on the specified user and the specified user's position, and automatically sets the location of the massage ceramic.

27. The massage mattress according to claim 21, wherein when the operation control unit confirms, from pressure information that changes over time, that a portion where a pressure equal to or greater than a predetermined value acts continuously on a predetermined area occurs, the operation control unit moves the massage ceramic to change the position to prevent bedsores.
